(19) United States
(12) Patent Application Publication
(10) Pub. No.: US 2006/0282900 A1
(43) Pub. Date: Dec. 14, 2006

(54) Managing access with resource control lists and resource replication

(75) Inventors: Gregory C. Johnson, Bellevue, WA (US); Nathan Daniel Muggli, Redmond, WA (US); Pranay Sadarangani, Bellevue, WA (US); William Birkin Lees, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/149,651

(22) Filed: Jun. 10, 2005

(51) Int. Cl. H04N 7/16

(52) U.S. Cl. 726/26

(57) ABSTRACT

Resources in a computerized environment can be organized into objects and resource groups, which are, in turn, managed by one or more resource control lists. For example, a computer system (i.e., an accessor) can be represented by an object at a managing computer system. The computer system object includes a resource control list that indicates what groups of objects can be accessed, and/or what groups of objects cannot be accessed. A request by the computer system for a resource, such as a user object, can involve the managing computer system identifying the computer system object, reviewing the resource control list for the computer system object, and then reviewing whether the requested resource is found in an accessible group. Additional implementations relate to ensuring that resources are accessed appropriately, such as at a point when all resource updates have been sent, received, and implemented for the given resource.

### CROSS-REFERENCE TO RELATED APPLICATIONS

N/A

### TECHNICAL FIELD

This invention relates to systems, methods, and computer program products for managing resources.

### BACKGROUND

As computerized systems have increased in popularity, so have the needs to distribute files and processing resources of computer systems in networks both large and small. In general, computer systems and related devices communicate information over a network for a variety of reasons, for example, to exchange personal electronic messages, sell merchandise, provide account information, and so forth. One will appreciate, however, that as computer systems and their related applications have become increasingly more sophisticated, the challenges associated with sharing data and resources on a network have also increased.

Generally, there are a number of different mechanisms and protocols for a distributing resources among computer systems. For example, two or more computers in a corporate network can share resources, such as files, application programs, or the like, over, for example, a Local Area Network (“LAN”), or a Wide Area Network (“WAN”). The computers can share these resources using any number of currently available transmit and receive communication protocols established between them.

In general, control over how resources are shared is often managed by an Access Control List (“ACL”). An access control list has the form of a list of access information, as the name implies, where access information is basically an access type, an allowed type, and an accessor identifier. An example of an access control list written on some resource might state that write access is granted to users A, B, and C; that read access is granted to users D, E, and F; and that full control is granted to user G. In many cases, access control lists are designated for a partition of storage, such as a folder in a directory, and each object (e.g., file) in that folder can be configured to inherit the access control list designated for that folder.

In one instance, access control lists can simplify the query: “given a file, what accessors can access this file?” Unfortunately, conventional access control lists do not necessarily simply the question: “given an accessor, what files can the accessor access?” For example, with this type of query, one or more modules in the operating system might need to perform an additional query on each individual file in the system, review the access control list for those discovered files, and create a list denoting each time the user is found in an access control list for a given file. This is typically a cumbersome process that can be exacerbated in systems with large numbers of potential files. This can be just as cumbersome, if not more so, when querying for more granular information, such as all of the files to which the accessor has write, read, or full access.

Other complications relating to resource sharing can include how resources are accessed when in the process of being updated. For example, a user may have a certain password at one moment in time, and may also have certain access to certain resources. If a system administrator changes the password (e.g., employment termination), or wants to deny the user access to one or more previously allowed resources, the system administrator might implement the relevant changes at one computer system, and replicate those changes down to computer system(s) (or relevant servers) where the user might have access.

A difficulty can arise, however, when there is some network latency or other processing delay that hinders the timing at which the computer system(s) receives the update. In particular, if the update to these resources is sent in incremental portions (e.g., the password is changed several times before settling on a final password), user access at the local system might be confused. For example, the user might try on several attempts to login with a new password, but the only updates received at the computer system relate to a prior, invalid password, or relate to some other unrelated resource, such that the computer system continually replies with an access denied message. Alternatively, the user might successfully log in to a local system with an old password since the change has not yet successfully replicated locally, even though the update is that the user should not login at all (e.g., has been terminated from employment).

One can appreciate therefore that there are a number of difficulties that can be found in present resource management and replication systems, which, in some cases, can also lead to a detrimental security effect.

### BRIEF SUMMARY OF SELECTED EMBODIMENTS

The present invention solves one or more of the aforementioned problems with systems, methods, and computer program products configured to provide a computer system with sufficient information to handle the various accessor needs in a secure and efficient manner. In particular, implementations of the present invention include resource control lists that can be used, among other things, to simplify how various accessors can access various resources. Additional implementations of the present invention include replication mechanisms that can ensure that resources, and any corresponding updates, are accessed when appropriate.

For example, one method in accordance with an embodiment of the present invention involves a computer system receiving a request from an accessor, such as a computer system, for access to one or more resources, such as a user object or an attribute thereof. The method also involves identifying an accessor object for the accessor, as well as identifying a resource control list in the accessor object. The method can further involve identifying that at least one of the requested one or more resources is associated with an allow classification in the resource control list. In addition, the method can involve sending a message indicating that the identified at least one of the requested one or more resources is accessible.

In addition, another method in accordance with an embodiment of the present invention involves a computer system receiving an indicator that a resource has been updated at another computer system, such as a hub, or server computer system. In addition, the method involves receiving one or more of components of a corresponding resource update from the hub domain controller. While receiving the updates, the method can also involve sending one or more responses, before all of the components have been received, that the resource is unavailable. In addition, the method also involves updating the resource after all of the components have been received, as well as responding to a different request for the resource in accordance with the updated resource.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a schematic overview of computer system in accordance with an implementation of the present invention in which a one or more queries posed to computer system Are handled based at least in part on partitioning of resources into group memberships;

FIG. 1B illustrates a schematic overview of two computer systems in which user account access is administered based on group membership criteria;

FIGS. 2A through 2B illustrate a schematic diagram of sending and receiving computer systems in a network in which a resource is requested in the middle of a receiving computer system receiving updates for the resource;

FIG. 2C illustrates the schematic diagrams as shown in FIGS. 2A-2B, in which the receiving computer system provides access to an updated form of the resource after all of the updates have been received from the hub computer system;

FIG. 3A illustrates a schematic diagram of sending and receiving computer system in which the managing computer system changes aspects of a resource, which are ultimately to be replicated to the receiving computer system;

FIG. 3B illustrates the schematic diagram of FIG. 3A in which all of the updates sent by the managing computer system have been received at the receiving computer system;

FIG. 4 illustrates a method in accordance with an implementation of the present invention for providing access to a resource based on a resource control list; and

FIG. 5 illustrates a method in accordance with the present invention for managing access to a resource in the context of a resource update.

### DETAILED DESCRIPTION OF EMBODIMENTS

The present invention extends to systems, methods, and computer program products configured to provide a computer system with sufficient information to handle the various accessor needs in a secure and efficient manner. In particular, implementations of the present invention include resource control lists that can be used, among other things, to simplify how various accessors can access various resources. Additional implementations of the present invention include replication mechanisms that can ensure that resources, and any corresponding updates, are accessed when appropriate.

Generally, as will be understood more fully from the following description and claims, resource access can be based on corresponding group assignments. For example, a managing computer system, such as a server managing access to one or more resources, can partition resources into one or more groups. The groups in turn are provided with a resource control list that indicates what resources permissions are available within the group. For example, the resource control list for one group can indicate that objects for User object 10 and User 20 have read access to one resource, or write access to another resource, while a resource control list for another group can indicate that objects for User object 10 and User object 30 have full control over another, different resource.

A computer system can also have a group object at the managing computer system, and the computer system object can also have its own resource control list. For example, the resource control list might indicate what user secrets can be read, or cached locally, and what user secrets might be denied to the computer system. The managing computer system can then respond to requests for certain resources based on how permissions are stated in the computer system object's resource control list. Thus, at least one implementation of the present invention simplifies the query: “what resource access does the User object A have?” since the relevant computer system need only query resource control lists of the groups for which “User A” is a member.

Additional or alternative implementations include provisions for replicating resource access and corresponding updates to receiving computer systems, such that the resources can be managed at a local level in an efficient, simple to manage, and secure fashion. For example, periodic updates of indicia between an originating computer system and another computer system can help ensure that the other computer system only provides access to authorized updates. For example, if a password or group membership is changed at the originating computer system, the originating computer system can send information to the other computer system in a manner that accommodates any network transmission delays, and still ensures that the other computer system prohibits access to out-of-date resources. As such, resource management is handled between computer systems in a highly efficient and secure manner.

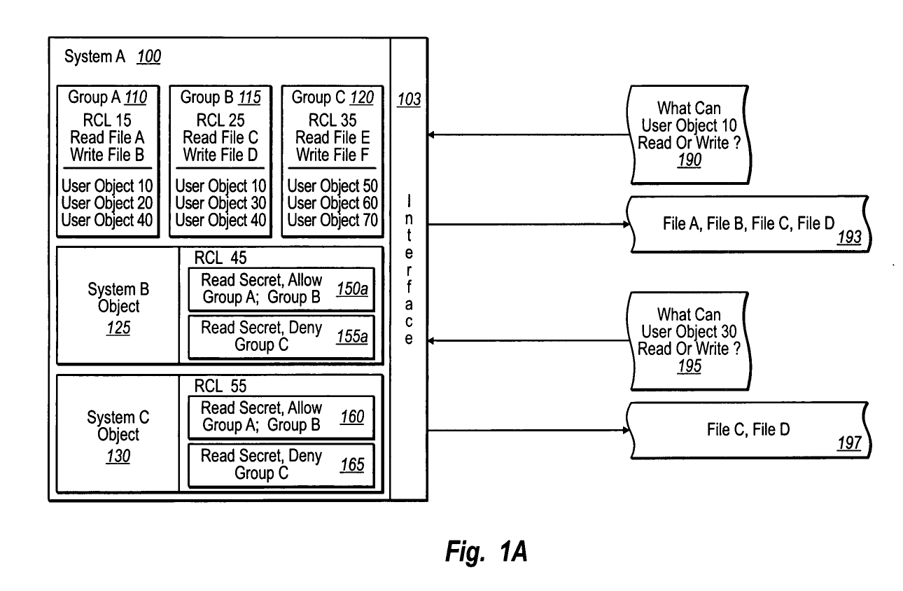

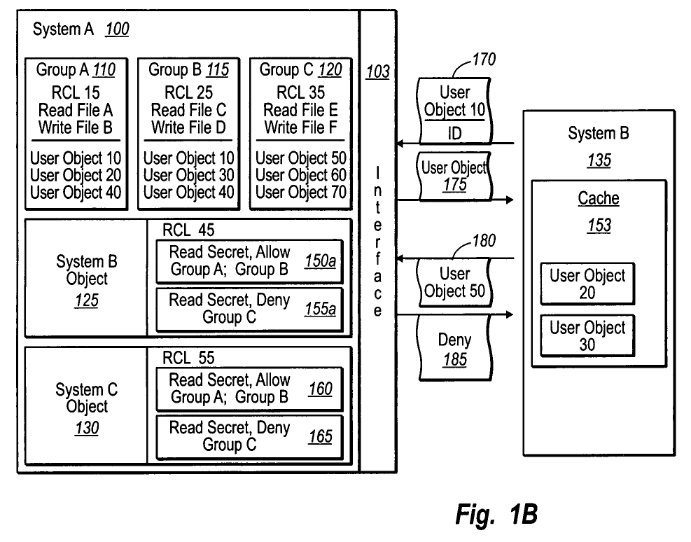

With respect to generalized partitioning and querying, for example, FIG. 1A shows a managing computer system A 100, such as a server that is configured to partition resources (e.g., local computer objects, and resource objects). In particular, FIG. 1A shows that managing computer system A 100 comprises at least Group A 110, Group B 115, and Group C 120, which each include a variety of User objects 10, 20, 30, 40, 50, 60, and 70, and at least one resource control list (“RCL”) 15, 25, 35 for each group. In one implementation, for example, a group is a status of resources, such as network administrator objects or branch manager objects that are allowed to access computer systems in a given network domain. In another implementation a group of resources is, for example, a certain class of user objects, such as employees that work on the fifth floor of a building, or all the staff in a given office complex. Another grouping might be a type of file, or all objects for certain peripherals (e.g., printers) available in a certain building. In general, resources are assigned to groups where each resource or accessor will have the same or similar status, and therefore have similar access to certain other resources.

As such, FIG. 1A also shows that each group partition (i.e., 110, 115, 120) at managing computer system A 100 includes one or more resources that can be accessed by one or more accessors. For example, as previously mentioned, a resource might be a user object, a printer object, a file, as well as a single attribute on a User object, such as a password. Other, more universally accessible resources can include such things as files, applications, or file systems that are to be accessible by certain accessors in a given group. For example, an organization might want to make a certain presentation file accessible to a group of managers, but not make the presentation file accessible to general staff. As such, although there are many types of resources, the following discussion will relate primarily to resources that are user objects for purposes of illustration.

Accordingly, FIG. 1A shows that Group A 110 comprises User object 10, User object 20, and resource control list (“RCL”) 15, which indicates that User objects 10 and 20 have “read” access to File A, and “write” access to file B. Similarly, FIG. 1A shows that Group B includes User object 10, User object 30, User object 40, and resource control list 25. Resource control list 25 indicates that User objects 10, 30, and 40 have “read” access to File C, and “write” access to File D. Furthermore, Group C 120 comprises User object 50, User object 60, User object 70, and resource control list 35. Resource control list 35 indicates that the members of Group C 120, i.e., User objects 50, 60, and 70, have “read” access to File E, and “write” access to File F.

FIG. 1A also shows that managing computer system A 100 includes an object for various computer systems (e.g., a separate, lower level computer system in a domain or network hierarchy). The objects 125, 130 for each computer system are managed with respect to access to one or more groups by corresponding resource control lists 45 and 55. For example, FIG. 1A shows that managing computer system A 100 has an object 125 for system B 135, which has a resource control list 45 indicating that secrets can be read for Group A (i.e., 110) and Group B (i.e., 115). The resource control list 45 for the system B 135 object 125 also indicates that secrets cannot be read for Group C (i.e., 120). Similarly, managing computer system A 100 includes an object 130 for another computer system C. The system C object 130 includes a resource control list 55 that allows secrets to be read for Group A 110, but does not allow secrets to be read for Group C 120.

In one implementation, this designation of secrets being readable means that the given computer system is allowed to store certain objects of the given groups in its cache. That is, those groups for which secrets can be read are “cacheable”, while those groups for which secrets cannot be read are “non-cacheable”. For example, computer system B 135 can cache resources (i.e., user objects in this case) of Groups A and B, but not for Group C; while the computer system C (not shown) can cache user resources of Groups A and C, but not for Group B.

Segmenting resource and computer system object information through resource control lists in this manner can create a much simpler way to organize and query the availability of resources given a certain parameter. For example, FIG. 1A shows that a query 190 posed to the system A 100 interface 103 requests information regarding resources that that can be read or written to by User object 10. Because the resources that are available are simply the resources in the groups to which User object 10 belongs, the interface 103 can readily return a response 193 that says User object 10 has read or write access to Files A and C. Similarly FIG. 1A shows that a query 195 posed, to interface 103 regarding the resources to which User object 30 can read or write results in a response 197 that User object 30 has read or write access to Files C and D. Notably, User object 30 has read or write access to fewer resources in this case since the User object 30 is only found in Group B 115, while User object 10 is found in Groups A 110 and B 115.

Furthermore, it will be appreciated that these exemplary queries can be further refined to where, or at what location, the user object can access the given resources. For example, managing computer system A 100 might respond in response to a different query that User object 10 has read access to Files A and C at computer system B 135 (e.g., 135, FIG. 1B), but only has read access to File A at computer system C 130 (not shown). Similarly, managing computer system A 100 could respond that the User object 30 has read access to File C at the location of computer system B 135, but cannot access any resources at the location of computer system C 130 (not shown). That is, in one implementation, the fact that Group B is not defined in the resource control list 55 for the system C object 130 is tantamount to a denial of access for any objects in Group B.

Beyond simplification of querying processes, the above-described partitioning of information can also allow computer systems in a network hierarchy to be implemented in a primarily “read-only” fashion, while incurring many of the benefits of having “write” capabilities. In particular, computer system B 135 can be configured to be written to by a higher level trusted source related to cacheable or non-cacheable groups, as well as any other appropriate configuration information. This has benefits related at least in part to manageability from the perspective of an administrator at a managing computer system A 100, as well as to network bandwidth concerns.

Despite being written-to by the trusted source, however, computer system B 135 can also remain primarily “read-only” with respect to local accessors. This can provide still additional security and manageability benefits at least for the local administrator of computer system B 135, as well as for any other local accessors. Thus, implementations of the present invention can accommodate a hybrid “read-only”/“writable” receiving computer system having combined advantages.

For example, FIG. 1B illustrates one implementation of how the resource control lists can be used to provide requested resource access at another computer system. In particular, FIG. 1B illustrates what can occur when an authorized accessor requests access to a resource, such as User object 10, but does not yet have a locally stored copy of the resource present at computer system B 135. FIG. 1B also illustrates what can occur when the computer system B 135 tries to access a resource, such as User object 50, for which computer system B 135 is not authorized.

For example, FIG. 1B shows that computer system B 135 requests access to User object 10 from the managing computer system A 100. As shown, computer system B 135 sends a corresponding request 170 to managing computer system A 100, which includes an identifier for the computer system B 135. In one implementation, the computer system B 135 identifier found in request 170 is a secret given previously by managing computer system A 100.

In any event, managing computer system A 100 interface 103 receives request 170, and determines if the credentials provided by computer system B 135 are appropriate. If the provided credentials/identification for computer system B 135 are/is incorrect, managing computer system A 100 replies with an error. If valid, however, then managing computer system A 100 also identifies appropriate resource access based on designations in the resource control list 45 for the system B 135 object 125.

In this case, FIG. 1B shows that the resource control list 45 allows secrets to be read for Group A and Group B, and that User object 10 is found in Group A 110 and Group B 115. The managing computer system A 100 therefore surmises that User object 10 can be sent to computer system B 135, and responds accordingly with a message 175 of allowance. Generally, message 175 also includes the requested User object 10, so that User object 10 can also be stored in cache 153 at computer system B 135. In some implementations, however, User object 10 can be sent in a separate message. In any event, the requesting computer system B 135 can then place User object 10 in its cache 153. This allows computer system B 135 to handle subsequent needs related to that object.

FIG. 1B also shows an instance of how the resource control list 45 on the system B 135 object 125 can be used to reject an access request for a user object. For example, FIG. 1B shows that computer system B 135 requests User object 50, which is represented in Group C 120. As shown, the resource control list 45 lists group C as part of those for which read access for secrets is denied on computer system B 135. Thus, in response to access request 180, managing computer system A 100 responds to computer system B 135 with message 185 that denies the request for the User 50 object. In one implementation, the message 185 also tells the receiving computer system to include the User object 50 in a local deny list of a local resource manager, such as a locally stored resource control list (not shown), for future reference. Thus, computer system B 135 can immediately deny future requests for that object 50 without necessarily needing to first interact with managing computer system A 100.

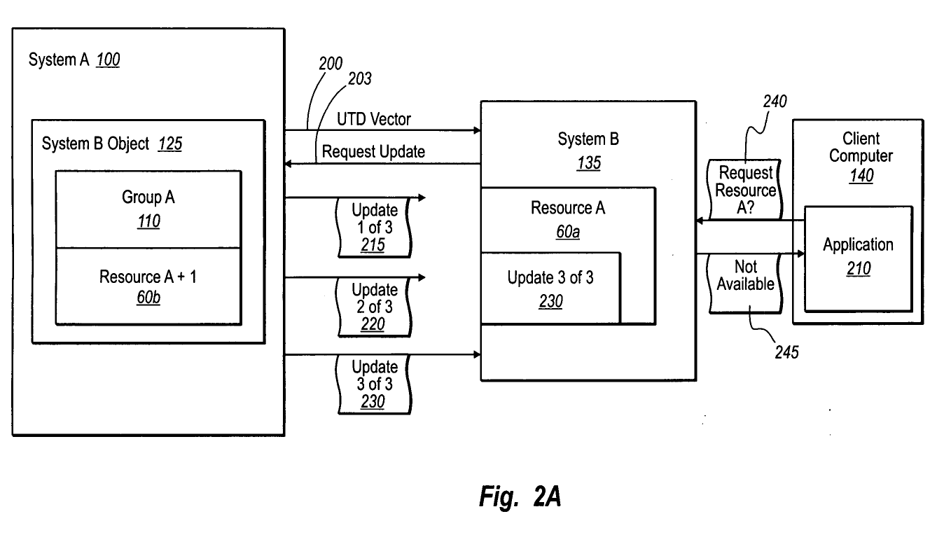

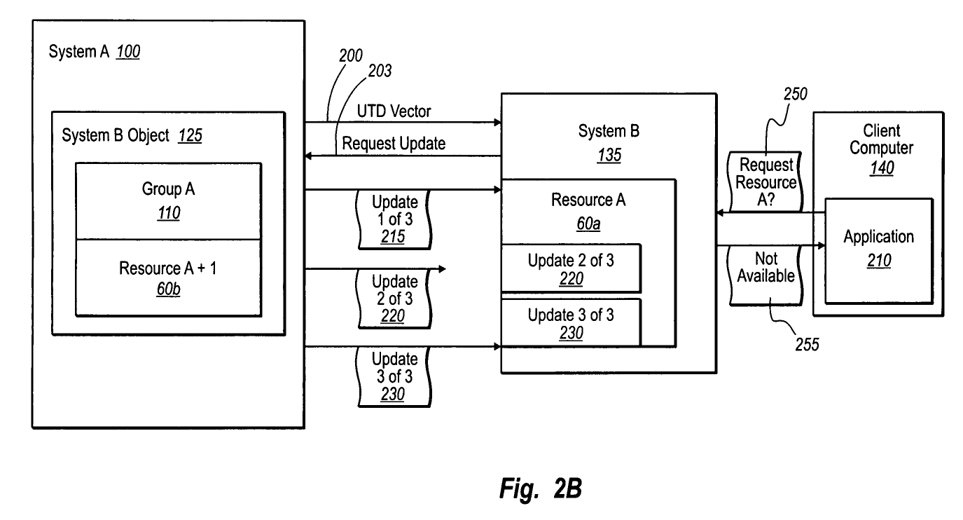

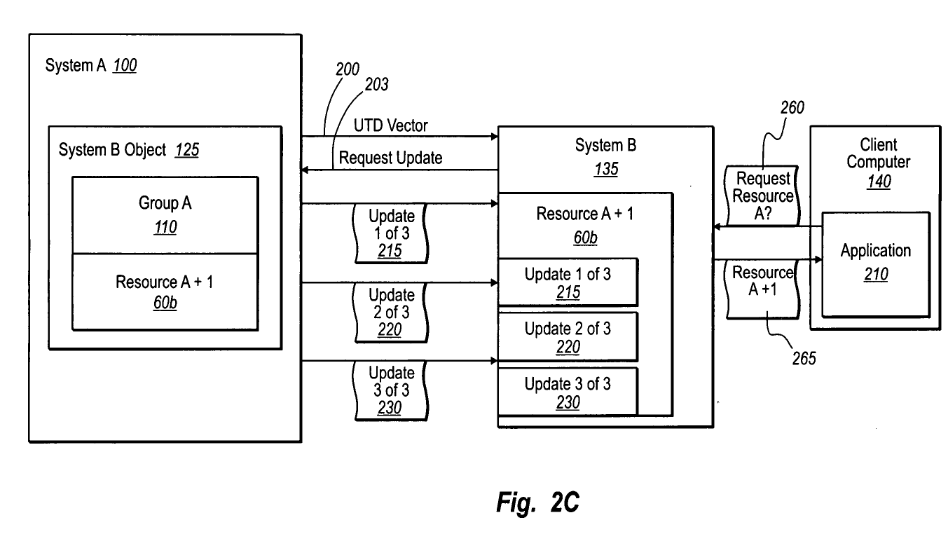

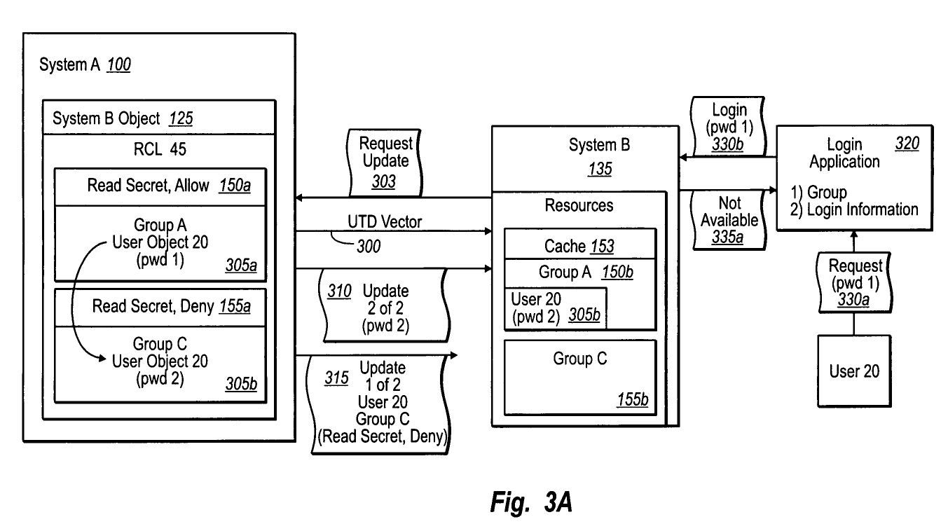

Accordingly, the schematic diagrams of FIGS. 1A through 1B illustrate exemplary implementations for managing resources in an efficient way for various accessors. In particular, FIGS. 1A through 1B show how resource control lists can be used to restrict and/or allow resource access to various accessors in conjunction with group memberships. That is, resource access for large groups of resources can be managed or changed simply by altering a resource control list for that group, and resource access for individual objects can be changed simply by moving one object in a group with one resource control list to another group with a different resource control list. FIGS. 2A through 3C, however, show how resource access can be managed in the midst of a change to a given resource.

In particular, FIG. 2A illustrates an overview of one implementation in which resources, and corresponding updates, can be coordinated between computer systems in a way that can accommodate certain communication delays, and still maintain resources are accessed as intended at each location. That is, implementations disclosed herein can help ensure that an accessor is prohibited from accessing a resource if a trusted computer system (e.g., managing computer system A 100) originating an update is sending the resource updates to the computer system where the accessor is requesting access of that resource.

For example, FIG. 2A illustrates an implementation where computer systems share resource versioning information to help coordinate the relative “up-to-dateness” of resources and resource access. Specifically, FIG. 2A shows that managing computer system A 100 sends an “up-to-dateness” (or “UTD”) vector 200 to computer system B 135. In one implementation, UTD vector 200 comprises a unique value formed from different resource metadata, such as data that indicate what version, date, or other timestamps are associated with various configuration and account objects at the given domain controller. UTD vectors, such as UTD vector 200, can be sent by both managing computer system A 100 and computer system B 135 in reciprocal, periodic fashion, to help ensure that both computer systems are signaled for changes or currency of certain information.

As shown, when computer system B 135 receives UTD vector 200, computer system B 135 quickly checks to see if the corresponding time stamp indicators in UTD 200 are the same as those stored locally. If the received UTD vector 200 does not match data for what is stored locally, FIG. 2A shows that computer system B 135 will need to request appropriate updates for the changed resources. For example, FIG. 2A shows that managing computer system A 100 has an updated “Resource A” 60 to “Resource A+1” 60b, while the resource stored at computer system B 135 is still “Resource A” 60a.

Accordingly, FIG. 2A shows that computer system B 135 sends a request 203 for an update of this or any other resource, as appropriate. As with other requests, request message 203 can also include authentication indicia (e.g., previously provided secret) for computer system B 135, which can help prevent other computer systems from inappropriate resource access. The foregoing exchange, however, is not necessarily required. In particular, replication of updates to another computer system may be triggered simply by sending the updates themselves, without having exchanged UTD vectors in the first instance.

In any event, FIG. 2A shows that managing computer system A 100 starts sending the updated resource 60b, “Resource A+1”, in three incremental components 215, 220, and 230. FIG. 2A also shows that, due to any number of delays, such as network transit or other processing delays, the third of three updates (i.e., update 230) arrives at computer system B 135 before the first of three and second of three increments (i.e., messages/components 215 and 220). Nevertheless, due to the identity and information contained in message 230, or due to the information contained in the UTD vector 200 previously received, computer system B 135 recognizes that it has not received all of the updates that should be received.

As such, when a request 240 is made for resource 60a during the update, such as where application 210 of local client computer 140 requests the resource, computer system B 135 replies with message 245 stating that the resource (i.e., “Resource A” 60a) is “unavailable”. This response continues to be true until all portions (e.g., 215 and 220) of the update are received and confirmed. For example, FIG. 2B shows that update portion 215 and update portion 230 have now been received, but that update portion 220 has not yet been received by computer system B 135. When the client computer 140 relays a new request 250 for resource 60a (i.e., “Resource A”) to computer system B 135, computer system B 135 continues to forbid access to the resource, replying with message 255 that the requested resource is not available.

By way of explanation, FIGS. 2A and 2B also show that the name of the resource, “Resource A”, remains the same to show primarily that computer system B 135 does not perform any changes on the resource until all updates have been received. This, however, is not required. In particular, computer system B 135 may incrementally update aspects of resource 60a with each received portion, if appropriate, but still nevertheless forbid access to resource 60a until all portions of the update are received. Where only the final update 230 is the one that matters, forbidding access until all aspects of the update have been received may not make a large difference. Where all the update portions are important to providing context to the update, however, it may be important to make sure all updates are received before making the changes.

For example, suppose an application 210 processed a resource for a pricing plan to move an employee's family to another branch office in another locale, which depended in part on the number of members in the family. One portion of the updates sent by managing computer system A 100 might include the number of members in the family, while another portion of the update might relate to an insurance status that the relevant employee was on maternity leave to have a child. The application 210 might be configured to process insurance information before processing an absolute number of members in the family, to ensure all information is correct in the pricing plan. Nevertheless, if the application 210 were allowed to process the resource when no insurance information had yet been received, the application 210 might be processing only the absolute number of members in the family, and hence information out of context.

Along these or similar lines, FIG. 2C shows that each of the update portions 215, 220, and 230 have now been received by computer system B 135. As such, computer system B 135 is able to update resource 60a to resource 60b, or “Resource A+1”, which is consistent with the version of resource 60b at managing computer system A 100. In one implementation, this is confirmed because computer system B 135 simply counts that it has received one of three, two or three, and three of three messages. In alternative implementations, this can occur because computer system B 135 identifies a separate message from managing computer system A 100 (e.g., a subsequently sent UTD vector) that lists all of the updates that should have been received, as well as an indication that no more updates have been sent beside those identified. In any event, computer system B 135 is now able to now provide access to the resource.

Thus, when the client computer system 140 relays a new request 260 for the resource, FIG. 2C shows that computer system B 135 can now respond in message 265 with resource 60b, or the “Resource A+1” object. Accordingly, the schematic diagrams of FIGS. 2A through 2C provide an overview of how systems in accordance with the present invention can ensure that accessors do not inappropriately access resources that should be updated before the given accessor attempts to access them.

FIGS. 3A and 3B illustrate more detailed examples of the diagrams shown in FIGS. 1A through 2C, wherein an object is changed at the hub domain controller 100 and subsequently updated at computer system B 135 in a secure fashion. In particular, FIG. 3A shows an example of where User object 20 is changed into a group that a cannot be accessed by computer system B 135, and also has a password attribute change for the User object 20. For example, a user moves office locations, and also changes passwords as part of a periodic company requirement. As part of this change, FIG. 3A shows that the resource control list 45 in computer system B 135 object 125 has a change in readability of certain data, such that the User 20 object is changed from a “Read Secret, Allow” status to a “Read Secret, Deny” status. For example, with reference to FIG. 1B, the User object 20 may have been moved from Group A, for which secrets are readable, to Group C, for which secrets are not readable. FIG. 3A also shows that User 20's password has changed to “pwd 2”.

The managing computer system A 100 then updates its UTD vector 300 in response to this change in the User 20 data. At the appropriate time, the managing computer system A 100 sends the UTD vector 300 to computer system B 135, and computer system B 135 requests a corresponding update with response message 303. As before, the response message 303 can include at least identification information for computer system B 135, such as a secret provided earlier by managing computer system A 100. If the managing computer system A 100 authenticates the request 303, the managing computer system A 100 sends the updates, which, in this case, may comprise separate message portions (or “components”) 310 and 315. That is, message 315 is update one of two, and message 310 is update two of two. Of course, as previously stated, this exchange is not required for receiving updates to a resource. In some implementations, the managing computer system A 100 may simply begin sending the updates to computer system B 135.

In any event, FIG. 3A shows that update 315 includes information that the User 20 object has been changed to a “Read Secret, Deny” status, or moved to group C 120, and update 310 includes information that User 20's password has changed to “pwd 2”. In at least one implementation, this information is sent in separate update messages (or “components”) to accomplish a variety of different ends. For example, the component of putting User 20 in a non-cacheable group may be “non-secure”, or does not necessarily need to be sent with encryption, while the component 310 that includes the password change may need to be sent with encryption. Accordingly, FIG. 3A shows that the updates 310 and 315 are sent separately, but that, due to any number or type of delays, message 310 (i.e., “2 of 2”) arrives first at computer system B 135.

Computer system B 135, however, recognizes information in the received message 310, or, for example, compares an identifier in the message with information from the UTD vector 300, and identifies that more messages are forthcoming. As such, FIG. 3A shows that the local domain controller changes the prior password (i.e., previously resource 305a) to “pwd 2”, 305b, but will still not allow access to resource 305b until all updates have been received that should be received. For example, FIG. 3A shows that User 20 sends a login request 330a using the original password (i.e., “pwd 1”) through login application 320. The login application 320 sends a request 330b, and then receives a response message 335a that the User 20's account is unavailable.

This can occur because computer system B 135 forbids account access while updates are being received in general, or due to a more specific configuration for the login application 320. For example, the login application 320 might be configured to first request the group information (i.e., Group A 110, B 115, or C 120) for the user before presenting the credential information. Thus, when the login application 320 requests the group information (e.g., cacheable/non-cacheable), and the group information for User 20 is still being updated, computer system B 135 will still respond that the login is not available, even though the password aspect of the resource has already been updated. That is, the user's access simply will not be processed until all appropriate updates have been received.

A symbolic example of how updates can be received and ultimately allowed to be accessed using update sequence numbers (or “USN”) and various UTDs for the hub domain controller 100 and for computer system B 135 is presented below. In this example, the term “CS” refers to a computer system, and the letters “X” and “Y” are identifiers for the computer systems (e.g., “CS X” might be managing computer system A 100, while “CS Y” might be computer system B 135). The letters “A”, “B”, “I”, and are resources that can be updated, and the abbreviation “id” refers to an identifier.

Let CS X have USN J, invocation id X′, and UTD=[(X′, J),(Y′, A)]

Let CS Y have USN B, invocation id Y′, and UTD=[(X′, I),(Y′, B)]

Operations originating on CS X are marked with tuples (X′, n) where n<=J (i.e., n represents a previous version of resource “J”). Operations originated on CS Y are marked with tuples (Y′, n), where n<=A (i.e., n represents a previous version of resource “A”), and are represented on CS X through replication (e.g., sending of updates 310, 315, FIGS. 3A-3B). Notably, the example that follows does not necessarily describe the situation where B>n>A, which is being represented on CS X or CS Y through replication.

In any event, assume a new change originates on CS X with components that originate in any particular order. For example, CS X changes object M and “attribute 3” (or “M.3”), and this change is marked with (X′, J+1). Furthermore, CS X changes object N and attribute “7” (or “N.7”), and this change is marked with (X′, J+2). Notably, therefore, each change is marked with the invocation “id” (e.g., “X′”) and originating USN (e.g., “J+2”), such that USN 1<USN 2 if change 1 happened before change 2. As such, CS X might have the following data for an updated resource “J”.
1) CS X: USNJ+2
2) CS X: UTD=[(X′, J+2), (Y′, A)], which contains
   a. M.3: (X′,J+1); and
   b. N.7: (X′, J+2)
      After some time, the state of the CS X and CS Y computer systems can be correlated through successfully communicated messages, such as discussed in the prior and following independent, non-sequential examples.

### Example State 1

1) CS Y: USN I+e (e is an arbitrary number, including 0)
2) CS Y has previously received an indication that CS X's present UTD tuple is (X′,J+2).
3) CS Y receives a message from CS X that contains no updates.
4) Result: UTD for CS Y=[(X′, I), (Y′, B+e)] (not updated)
   In this example, CS Y may have received or originated some changes, but these changes are not the changes of present interest, and did not therefore result in any changes to the tuple for X′ in the CS Y UTD.

### Example State 2

1) CS Y: USN I+e (e is at least 1)
2) CS Y has previously received an indication that CS X's present UTD tuple is (X′,J+2).
3) CS Y receives an update from CS X that includes
   a. M.3: (X′, J+1)
4) Result: UTD for CS Y=[(X′, I), (Y′, B+e)] (not updated)
   In this example, CS Y has received at least the change “M.3”, but this replication did not yet result in any changes to the UTD at least in part since “N.7” has not yet been received, and since the received tuple for CS X in this message is “X′, I”, which is less than the known tuple of “X′, J+2”.

### Example State 3

1) CS Y: USN I+e (e is at least 1)
2) CS Y has previously received an indication that CS X's present UTD tuple is (X′,J+2).
3) CS Y receives an update from CS X that includes
   a. N.7: (X′,J+2).
4) Result: UTD for CS Y=[(X′, I), (Y′, B+e)] (not updated)
   In this example, CS Y has received at least the change “N.7”, but this replication did not yet result in any changes to the UTD at least in part since “M.3” was not yet received, and since the received tuple for CS X in this message is “X′, I”, which is less than the known tuple of “X′, J+2”.

### Example State 4

1) CS Y: USN I+e (e is at least 2)
2) CS Y has previously received an indication that CS X's present UTD tuple is (X′,J+2).
3) CS Y receives an update from CS X that contains
   a. M.3: (X′, J+1); and
   b. N.7: (X′, J+2).
4) Result: UTD for CS Y=[(X′, I), (Y′, B+e)] (not updated)
   In this example, CS Y has received both the changes “M.3” and “N.7”, but this replication did not yet result in any changes to the UTD since the received tuple for CS X in this message is “X′, I”, which is less than the known tuple of “X′, J+2”.

### Example State 5

1) CS Y: USN I+e (e is at least 2)
2) CS Y has previously received an indication that CS X's present UTD tuple is (X′, J+2).
3) CS Y receives an update from CS X that contains
   a. M.3: (X′, J+1);
   b. N.7: (X′, J+2).
4) CS Y also receives the UTD from CSX that states
   a. UTD=[(X′, J+2),(Y′, B+e)],
5) Result: UTD for CS Y=[(X′, J+2), (Y′, B+e)] (updated)
   In this example, CS Y has received both the changes “M.3” and “N.7”, and this replication from CS X is acknowledged in the UTD, either found in the update, or sent and received subsequently. That is, the received UTD “X′, J+2” in the update message is the same as the known UTD value for CS X of “X′, J+2”.

Accordingly, Example State 5 represents a complete replication with respect to the two changes made on X (meaning that the changes replicated, and are reflected in the UTD vector on CS Y). It is not important whether the foregoing changes originated on CS X or on CS Y. The UTD vector entries can be used to infer the source of the change. In any event, if an application (e.g., application 320) using “M” and “N” at CS Y (e.g., computer system B 135), wants to make a decision based on “M” and “N” that reflects changes made at CS X (e.g., managing computer system A 100), and the application is configured to follow the change order of “M”, then N, the application can test whether the data on CS Y is ready. In particular, the tuple of the attribute change on N reads (X′, J+2). Thus, with reference to the above-described Example States:

### Example States 1 through 4

1) J+2>I
2), Result: the application needs to wait and retry later, hopefully after replication has completed.

### Example State 5

1) “J+2”=“J+2”
2) Results: the application can be assured that any changes created before the attribute change to N are reflected on CS Y.

For example, FIG. 3B provides a schematic illustration of how computer system B 135 might respond after all the corresponding updates have been received, and all appropriate vectors have been acknowledged and/or confirmed for the received updates. In particular, now that messages 310 (e.g., “M.3”) and 315 (e.g., “N.7”) are received, and computer system B 135 has received some indication (e.g., by comparison with data from the UTD vector 300) that there are no more messages to be received, computer system B 135 (and/or relevant application) can then process the messages in any appropriate order. For example, FIG. 3B shows that the User object 305b is rendered unusable in the Group A partition 150b within cache 153, and the updated User 20 object is moved to the Group C partition 155b. That is, the password attribute of User 20's object has now changed, but the User 20 object is also no longer available at computer system B 135.

Thus, when User 20 sends a login request 330a to the login application using any password (i.e., “pwd 1” or “pwd 2”), the login application 320 sends a corresponding login request 330b that first checks for group information. The computer system B 135 can then respond that the resource is available, but with a message 340 that access is denied since the user object is part of a group for which computer system B 135 cannot read secrets.

Accordingly, the foregoing schematic diagrams, example, and descriptions provide a number of ways in which resources within systems can be efficiently managed in a secure and relatively simple manner. In particular, the foregoing schematic diagrams and descriptions show simple ways for managing resources using resource control lists based on group memberships, as well as safety measures that can help ensure that lags in replication do not allow inappropriate access to resources.

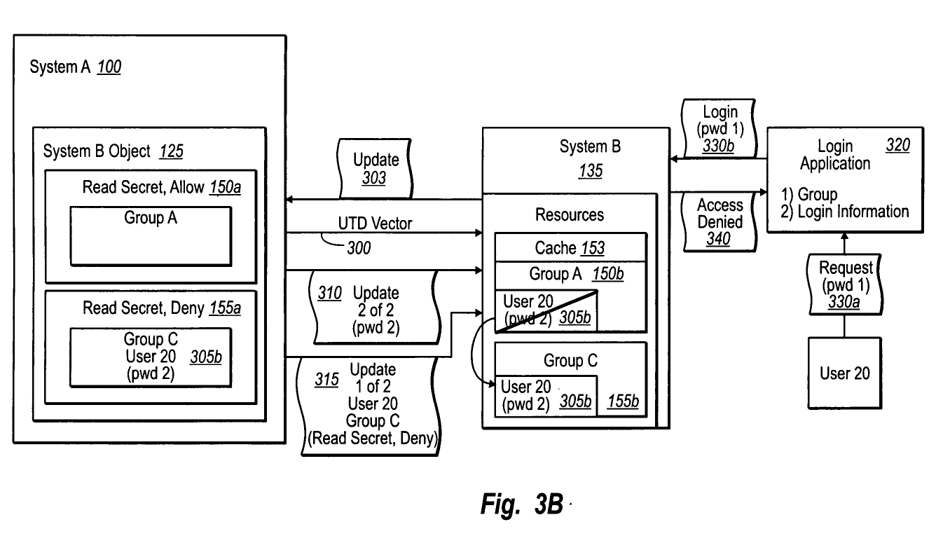

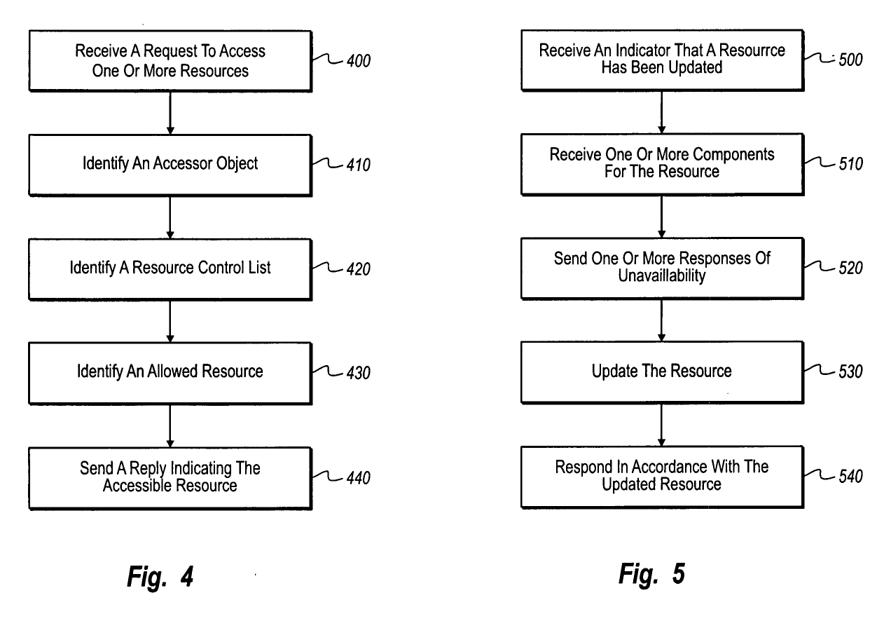

The present invention can also be described in terms of acts for accomplishing a method in accordance with the present invention. In particular FIGS. 4 and 5 illustrate methods from the perspective of computer systems A 100 and B 135 for managing resources. The methods described with FIGS. 4 and 5 are also described in terms of the schematic diagrams in FIGS. 1 through 3B.

For example, FIG. 4 shows that a method for managing resources in an easy and secure manner comprises an act 400 of receiving a request to access one or more resources. Act 400 includes receiving a request from an accessor for access to one or more resources. For example, as shown in FIG. 1A, a query is prepared, such as by a network administrator at computer system A 100, or by another computer system B 135, and sent to interface 103. The message 190 regards the files that can be read or written to by User object 10. Alternative, similar queries can be made regarding what user objects have secrets that can be read by a computer system, or, for example, given a resource, what user objects can access the given resource.

In addition, the method of FIG. 4 comprises an act 410 of identifying an accessor object. Act 410 includes identifying an accessor object for the accessor. For example, as shown in FIG. 1B, managing computer system A 100 identifies that the requester, computer system B 135 is represented by an object 125 that has a resource control list. In another situation, such as shown in FIG. 1A, a query for what the accessor can access involves first finding an object for the accessor, such as User object 10, and identifying in what group(s) the object is found. FIG. 4 also shows that the method comprises an act 420 of identifying a resource control list. For example, managing computer system 100 identifies any one or more of resource control lists 15, 25, 35, 45, or 55, as appropriate for the request, and for an object associated with the accessor making the request, or for whom/which the request is made.

In addition, FIG. 4 shows that the method comprises an act 430 of identifying an allowed resource for the object. Act 430 includes identifying that at least one of the requested one or more resources is associated with an allow classification in the resource control list. For example, as shown in FIG. 1A, managing computer system A 100 identifies resource control list 15 and 25 for the groups (i.e., Groups A 110 and B 115) in which User object 10 is found. The resource control lists 15 and 25 indicate that User object 10 has permissive “read” authorization for Files A and C, and permissive “write” authorization for Files B and D. Similarly, as in FIG. 1B, managing computer system A 100 identifies that the object 125 for computer system B 135 has “Read Secret, Allow” authorization for Groups A 110 and B 115, which are each populated by one or more user objects.

FIG. 4 further shows that the method also comprises an act 440 of sending a reply indicating the accessible resources. Act 440 includes sending a reply message indicating that at least one of the requested one or more resources is accessible. For example, as shown in FIG. 1A, managing computer system A 100 sends response 193 indicating that User object 10 has read or write access to File A, File B, File C, and File D. Similarly, as shown in FIG. 1B, managing computer system A 100 sends message 175 in response to request 170, where message 175 indicates that User object 10 is accessible. In some cases, message 175 will also contain User object 10.

FIG. 5 illustrates a method of managing one or more resource updates in a simple, effective, and secure manner between computer systems. For example, FIG. 5 shows that a method in accordance with an implementation of the present invention comprises an act 500 of receiving an indicator that a resource has been updated. Act 500 includes receiving an indicator that a resource has been updated at an originating computer system, the resource having at least a first and second component. For example, computer system B 135 receives UTD vector 200, as shown in FIG. 2B, which indicates that one or more resources at the managing computer system 100 (that originated the change in this instance) have changed. In one implementation, UTD vector 200 also indicates that the changed resource has multiple components that must be received before the resource can be changed at a computer system B 135. This can include update sequence identifiers (“USN”) associated with each update component, as well as identifiers for the managing computer system A 100 that originated the change. In alternative implementations, the computer system receives an indicator that an update has taken place simply by beginning to receive updates from the computer system that originated the change.

FIG. 5 also shows that the method comprises an act 510 of receiving one or more components for the resource. Act 510 includes receiving one or more components of a corresponding resource update from the originating computer system. For example, as shown in FIG. 2B, computer system B 135 receives updates 215 and 230, even though update 220 has been sent by the originating computer system 100, but not yet received at computer system B 135.

In addition, FIG. 5 further shows that the method comprises an act 520 of sending one or more responses of unavailability. Act 520 includes sending one or more responses, before all of the components have been received, that the resource is unavailable. For example, FIG. 2B shows that, since update 220 has not been received, computer system B 135 responds to an application request 250 with a message 255 indicating that the requested resource is not available.

Furthermore, FIG. 5 shows that the method from the computer system perspective comprises an act 530 of updating the resource. Act 530 includes updating the resource after all of the components have been received. For example, as shown in FIG. 2C, after all appropriate updates (i.e., updates 215, 220, and 230) have been received at computer system B 135, computer system B 135 changes “Resource A” 60a to “Resource A+1” 60b, and allows appropriately authorized users (or accessors) to access resource 60b. Accordingly, FIG. 5 shows that the method also comprises an act 540 of responding in accordance with the updated resource. Act 540 includes responding to a different request for the resource in accordance with the updated resource. For example, FIG. 2C shows that once resource 60a has been updated to resource 60b, computer system B 135 allows access to the updated resource 60b, replying in response to request 260 with response message 265 that includes the updated resource.

The foregoing methods, therefore, provide a number of ways for ensuring that resources, and corresponding updates, are managed effectively in a way that preserves security and at the same time allows easy management of resources at a computer system. In particular, implementations of the present invention allow for simple queries to be made on fairly granular levels of information, and allows secure resources to be managed in a way that the secure resources are not necessarily vulnerable to compromise when the resources are being changed.

One will appreciate that embodiments of the invention include or are incorporated in computer-readable media having computer-executable instructions or related data structures stored thereon. Examples of computer-readable media or computer program products include the volatile or non-volatile storage media, including but not limited to RAM, ROM, EEPROM, Flash media, CD-ROM, DVD, or other optical or magnetic storage, as well as any corresponding optical or magnetic storage devices, and/or any other media capable of storing electronic computer-executable instructions or related electronic data structures that are capable of being accessed and/or processed by a general purpose or special purpose computerized system. Computer-readable media also encompasses any appropriate combinations of the foregoing.

Computer-executable instructions comprise, for example, general text instructions in the case of scripts, or compiled instructions in the case of compiled program code, and/or relevant data that are read by one or more components of a general purpose or special purpose computerized system. When read, interpreted, and/or executed, these instructions cause one or more processors of the general purpose or special purpose computerized system (or special purpose processing device) to execute a function or group of functions. As such, computer-executable instructions and associated data structures represent an example of program code means for executing the acts or steps of the invention disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a computerized environment in which one or more computer systems communicate secure and non-secure information, a method of managing resources such that resource access can be easily identified and shared between computer systems in a secure manner, comprising the acts of:
receiving a request from an accessor for access to one or more resources;
identifying an accessor object for the accessor;
identifying a resource control list;
identifying that at least one of the requested one or more resources is associated with an allow classification in the resource control list; and
sending a message indicating that the identified at least one of the requested one or more resources is accessible.

2. The method as recited in claim 1, wherein the request includes a query regarding the identity of one or more files or peripheral devices that can be accessed by a user object.

3. The method as recited in claim 1, wherein the request includes a query regarding the identity of user objects that can be read by the accessor.

4. The method as recited in claim 1, wherein the query includes a request regarding an identity of one or more user objects that can access a particular one of the one or more resources.

5. The method as recited in claim 4, wherein the one or more user objects are found in a grouping having access permissions defined by the resource control list.

6. The method as recited in claim 1, further comprising:
receiving a request for a first resource, wherein the resource control list indicates that the first resource is in a group that cannot be accessed by the accessor; and
replying that the accessor does not have access to the first resource.

7. The method as recited in claim 1, wherein the request comprises a query for resources accessible to a first user object and to a second user object, wherein the first user object is associated with a first group having a first resource control list, and wherein the second user object is associated with a second group having a second resource control list.

8. The method as recited in claim 7, further comprising, responding based on information contained in the first and second resource control lists that the first user object can access a first set of resources.

9. The method as recited in claim 8, further comprising responding that the second user object can access a second set of resources, wherein the first set of resources and the second set of resources are different.

10. In a computerized environment in which one or more computer systems communicate secure and non-secure information, a method of correlating updates to one or more resources between computer systems in a simple and secure manner, comprising the acts of:
receiving an indicator that a resource has been updated at an originating computer system;
receiving one or more components of a corresponding resource update from the originating computer system;
sending one or more responses, before all of the one or more components have been received, that the resource is unavailable;
updating the resource after all of the one or more components have been received; and
responding to a new request for the resource in accordance with the updated resource.

11. The method as recited in claim 10, wherein responding to the new request for the resource in accordance with the updated resource comprises providing the updated resource to the requester.

12. The method as recited in claim 10, further comprising identifying that all of the components have been received.

13. The method as recited in claim 12, wherein the indicator is a vector that includes an identifier for the originating computer system, and a new update sequence number.

14. The method as recited in claim 13, wherein identifying that all of the components have been received includes identifying an update sequence number associated with each of the components.

15. The method as recited in claim 14, further comprising receiving a message that indicates that no more components for the update are being sent from the originating computer system.

16. The method as recited in claim 15, wherein the message includes the originating domain controller identifier and the new update sequence identifier.

17. The method as recited in claim 10, wherein the update to the resource includes any of changing an access permission for a first grouping of the resource to a new access permission, or of changing a location of the resource from the first grouping to a second grouping.

18. The method as recited in claim 17, wherein the update to the resource further includes changing an old password attribute to a new password attribute in the resource.

19. The method as recited in claim 17, further comprising:
receiving the new request from an accessor; and
identifying that the accessor has an object is associated with the new access permission that does not allow the resource to be accessed by the accessor, such that a response in accordance with the updated resource includes a denial of access.

20. In a computerized environment in which one or more computer systems communicate secure and non-secure information, a computer program product having computer-executable instructions stored thereon that, when executed, cause one or more processors at a computer system to perform a method comprising the following:
receiving an indicator that a resource has been updated at an originating computer system;
receiving one or more components of a corresponding resource update from the originating computer system;
sending one or more responses, before all of the one or more components have been received, that the resource is unavailable;
updating the resource after all of the one or more components have been received; and
responding to a new request for the resource in accordance with the updated resource.
